(19) United States
(12) Patent Application Publication
(10) Pub. No.: US 2012/0284331 A1
(43) Pub. Date: Nov. 8, 2012

(54) Processing Notifications

(76) Inventors: Karthik Shashank Kambatla, West Lafayette, IN (US); Jun Li, Mountain View, CA (US)

(21) Appl. No.: 13/100,073

(22) Filed: May 3, 2011

(51) Int. Cl. G06F 15/16

(52) U.S. Cl. 709/204

(57) ABSTRACT

A method of processing notifications is provided herein. A plurality of notifications is generated for a plurality of subscribers to a plurality of topics. The plurality of notifications is generated based on a plurality of events comprising the plurality of topics. The plurality of notifications is sent for the plurality of subscribers. Sending the notifications is performed concurrently with generating a second plurality of notifications for a second plurality of subscribers to a second plurality of topics. The second plurality of notifications is generated based on a second plurality of events comprising the second plurality of topics.

### BACKGROUND

Event-based interaction is a software interaction pattern that allows the event sender to deliver an event, and the event receiver to receive the event, through an event mediator. Event-based interaction allows asynchronous interaction between the event sender and the event receiver. That is, the event sender does not need to wait indefinitely for the event receiver to receive and respond to the event. Event-based interaction enables distributed software applications to form loosely coupled workflows that achieve business objectives. One particular type of event-based interaction is publish/subscribe, in which an administrative facility is responsible for creating and deleting topics. Users subscribe to topics of interest, creating a subscription list corresponding to each user. When a publisher publishes an event to a particular topic, the system matches the published event against the user subscription list and notifies the topic subscribers (users interested in the topic) of this event. For example, sales on DVD players may be a topic of interest to a client. Clients may receive notifications of sales on DVD players by subscribing to a DVD sale topic. Sales events and prices may then be provided as events from a content provider, such as a DVD player retailer.

In a cloud computing environment, notification service can be used to integrate cloud-based applications and services that belong to many different enterprises in a loosely coupled manner. Examples include: event-based distributed workflows, system health monitoring, and real-time alerting.

However, typical approaches have limitations, such as scalability. In some cases, vendors of notification services use proprietary software that inherently limits the number of events and subscriptions. Some notification services do not filter by content or through user-defined functions. User-defined functions may filter by specific conditions, such as merely sending sales notifications if a threshold value is met, e.g., a 10% discount. Another approach involves messaging queues. To achieve event routing efficiency, messaging queues typically support topic-based matching with simple matching rules, such as matching against topic names. However, each different subscription to a messaging service corresponds to a distinctive piece of code that a developer implements and installs. As such, with messaging busses, the number of subscriptions per topic is limited.

### BRIEF DESCRIPTION OF THE DRAWINGS

Certain embodiments are described in the following detailed description and in reference to the drawings, in which:

FIG. 1 is a process flow diagram of a method for processing notifications in accordance with an embodiment;

FIG. 2 is a block diagram of a notification service in accordance with an embodiment;

FIG. 3 is a block diagram of a shared cluster environment in accordance with an embodiment;

FIG. 4 is a data flow diagram of pipeline stages in accordance with an embodiment;

FIG. 5 is a block diagram of a system for processing notifications in accordance with an embodiment; and

FIG. 6 is a block diagram showing a non-transitory, computer-readable medium that stores code for processing notifications in accordance with an embodiment.

### DETAILED DESCRIPTION

Computing technology is increasingly shifting towards hosting applications in a cloud environment. The cloud environment provides a large pool of compute and storage resources to allow a hosted application to elastically scale up and down horizontally with respect to the number of compute and storage resources, in order to meet the demands to consume the application at real-time. A common, efficient notification mechanism may be useful for various cloud-based applications to communicate processing status and results in real-time to interested parties, and to quickly send notifications to responsible parties. Notifications may describe issues, such as machine load spikes, loss of sensitive data, and privacy violations (accessing data in a protected environment). Notifications may also describe personalized product offerings.

In one embodiment, a scalable publish/subscribe based notification service may process large volumes of events and subscriptions, efficiently and reliably. The events and subscriptions may be from any number of applications belonging to different enterprises. The notification service may include two multi-staged execution pipelines that run concurrently in a shared cluster environment.

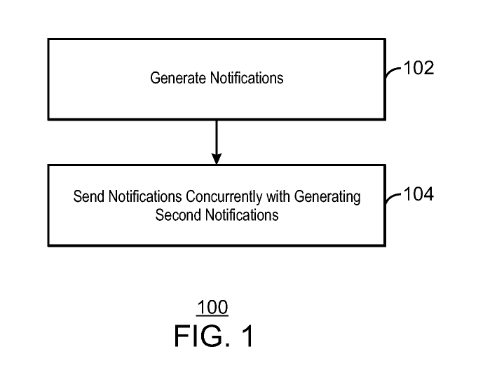

FIG. 1 is a process flow diagram of a method 100 for processing notifications in accordance with an embodiment. It should be understood that the process flow diagram is not intended to indicate a particular order of execution. The method 100 may be performed by a notification service.

The method 100 begins at block 102, where notifications may be generated based on published events. Numerous events may be received from numerous publishers. Subscribers to the events' topics may be identified. Notifications may then be generated for each subscriber and event.

At block 104, the notifications may be sent to the subscribers concurrently with the generation of a second set of notifications. The notifications generated at block 102 may be aggregated by subscriber. In this way, one notification may be sent to each subscriber. The notification may include all the event notifications for one subscriber. The second set of notifications may be concurrently generated for a second set of published events.

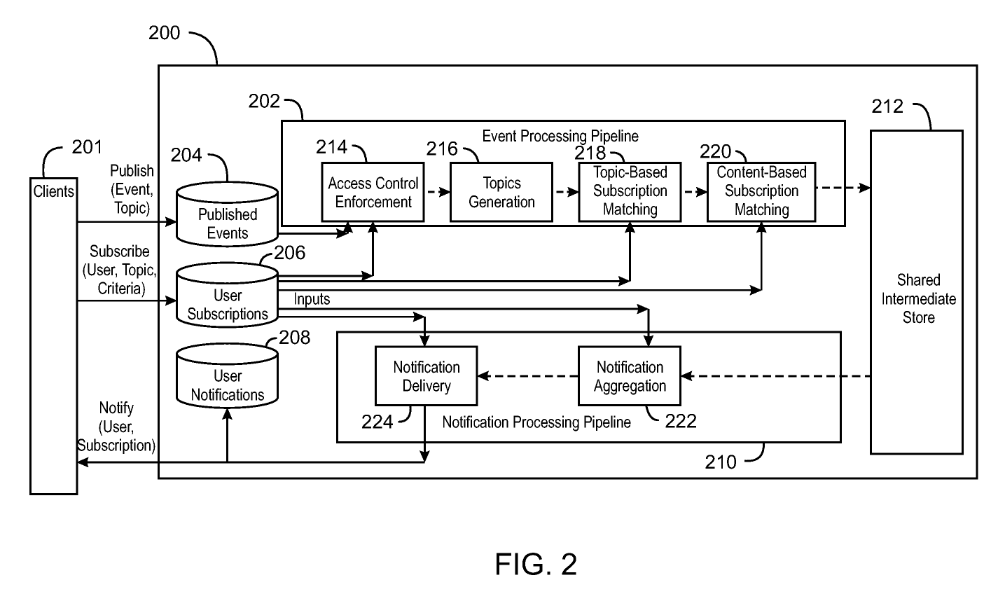

FIG. 2 is a block diagram of a notification service 200 in accordance with an embodiment. The notification service 200 may perform the method 100, in interactions with clients 201. The notification service 200 may include an event processing pipeline 202, events 204, subscriptions 206, notifications 208, a notification processing pipeline 210, and a shared intermediate store 212.

The clients 201 may include computational devices, such as personal digital assistants, laptop and desktop computers, mobile devices, etc. The clients 201 may also participate in particular roles with the notification service 200. These roles may include those of a publisher and a subscriber. The publisher, such as a merchant, may publish an event, e.g., a product sale to the notification service 200. A subscriber may subscribe to notifications about the merchant's sales. Accordingly, the subscriber may receive a notification regarding the sale event. In one embodiment, subscribers may subscribe to topics for notifications. The topics may be subject areas for categorizing events, specified by the administrator of the publish/subscribe system.

The notification service 200 may be exposed as a service that supports application programming interfaces (APIs) for publishing events 204, subscribing to topics, and receiving notifications. Being exposed means that the notification service 200 is accessible through these APIs. The API for publishing events 204 may enable a client to publish an event 204 to a topic that has been registered to the service 200. The API for subscribing to topics may enable the client to specify criteria for filtering notifications based on a subscription to a topic. The notification service 200 may also provide notifications to clients 201. Using the API for notification, the client 201 may be notified of a published event 204, based on a subscription and specified matching criteria for the client 201.

In one embodiment, each of the published events 204, the subscriptions 206, and the notifications 208 may be stored in different, scalable, structured data stores. These data stores may also include a history of published events 204 and notifications 208 for purposes such as auditing.

The event processing pipeline 202 may generate notifications to be delivered to subscribers, based on events 204 received from publishers. The publishers publish the events through the publish-related API, which requires two parameters, the event and the associated topic. The event can be the 5% discount on the product, and the topic can be the product type, for example, the DVD player. The generated notifications may be placed in the shared intermediate store 212. The notification processing pipeline 210 may retrieve the notifications from the store 212, and deliver the generated notifications. The work of the pipelines 202, 210 may be performed in stages. The processing of each stage of the pipelines 202, 210 may be performed, respectively, by scalable matching, and notification delivery engines.

The event processing pipeline 202 may include four stages. Stage 214 may perform access control enforcement. The stage 214 may ensure that sources of the published events 204 are authorized to participate in the notification service 200, according to the topic-specific policies that are defined by the system administrator. For example, a particular event publisher, who is a merchant, is only entitled to publish events to the topics related to electronics, but not others. In other words, events 204 that violate pre-defined topic-based policies may be filtered out of the event processing pipeline 202.

Stage 216 may perform topic generation for all the published events 204 that have passed the access control filtering stage 214. The stage 216 may retrieve topics for the published events 204, and generate a tuple that can be represented as <topic, event>. That is, each tuple may include a topic and an event. The output of the stage 216 is the aggregation of the events that fall into the same topic, and thus can be represented as <topic, event list>. The stage 218 may perform topic-based subscription matching, which identifies subscriptions 206 to the topics that are involved in the published events. For each <topic, event list> pair, it produces a collection of <user, notification> pairs. The stage 220 may perform content-based subscription matching, where filtering criteria, e.g., developer-defined and user-defined functions, may be applied.

Such content-based filters may be used when the client 201 specifies a preference for a specific subset of events published to a topic. For example, in the case of product sale, the user-defined function may specify that the client is only interested to be notified if the DVD player on sale has the discount price of at least $20.

The user defined functions may be stored in association with the subscriptions 206 of clients. Content-based matching may involve looking up those functions and applying them to the relevant notifications. The output of content-based matching, the final notification records, may be written to a distributed data store. These records may be asynchronously consumed by the scalable notification delivery pipeline 210.

The event processing pipeline 202 may generate notifications, and store the notifications in the scalable shared intermediate data store 212. The notification processing pipeline 210 may process those notifications that are newly added to the shared intermediate data store 212. When the notifications are pushed to the shared intermediate store 212, they may initially be marked as “un-processed.” Once the notifications are processed by the notification processing pipeline 210, the processed notifications may be marked as “processed.” The notification processing pipeline 210 includes two stages. The first stage 222 may perform notification aggregations, such that multiple notifications are delivered to the same client 201, e.g., when these notifications share a same endpoint (for example, the same mailbox) and protocol (for example, through email), in a single notification message (for example, an email message). The second stage 224 may package the notification message to each client 201 over the channel specified by the client when the client makes the subscription to the topic. In one embodiment, notifications may be delivered in the presence of transient failures. For example, a failed notification delivery may be re-delivered by the second stage (224) in a subsequent execution of the pipeline 210.

The notification service 200 may be implemented in a MapReduce environment. The MapReduce execution environment allows the distributed execution of MapReduce jobs over a collection of nodes (one master and the remaining slave nodes). A MapReduce job is executed in two phases—map and reduce. The map phase takes a list of key-value pairs as input and applies the programmer-specified map function independently on each pair in the list. The resultant key-value pairs are aggregated by key to form a list of <key, list of values> pair. The reduce phase applies the programmer-specified reduce function to each constituent <key, value list> pair; and outputs yet another list of key-value pairs. Each phase involves distributed execution of map and reduce tasks on a collection of computing nodes—a task is responsible for applying the relevant programmer-specified function to a subset of the input. Accordingly, the stage 216 may be implemented as a Map phase, and stage 218 may be implemented as a corresponding Reduce phase.

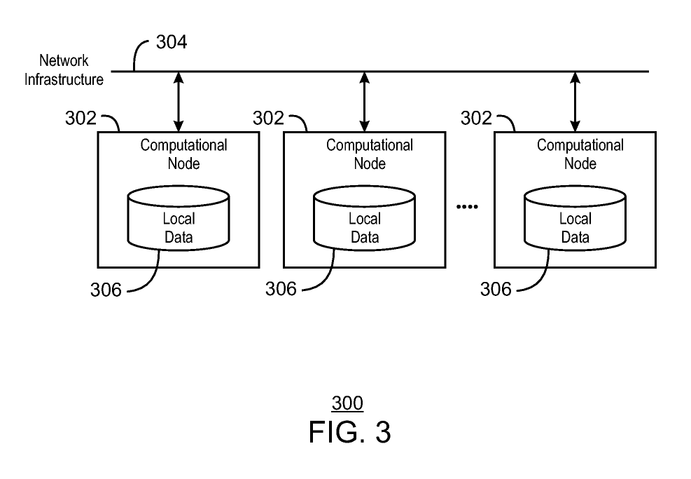

In one embodiment, the inputs to stage 224 are received from a distributed data store that is evenly partitioned and distributed to various computational nodes of a shared cluster environment. FIG. 3 is a block diagram of a shared cluster environment 300 in accordance with an embodiment. The shared cluster environment 300 may include multiple computational nodes 302, in communication over a network infrastructure 304. In a shared cluster environment, each stage of pipelines 202, 210 may be mapped to multiple computational nodes 302, and executed in a distributed fashion. Similarly, the data used for each stage, e.g., user subscriptions for stage 218, may be mapped to multiple local storage 306, enabling the distributed execution of each stage.

Referring also to FIG. 2, the inputs to the first stage of both pipelines 214 and 222 may be evenly split across the computational nodes 302 performing the first stages 214 and 222. In the subsequent pipeline stages, the computational node 302 in a stage may receive the processing inputs from at least one of the computation nodes 302 that are performing the immediate predecessor stage. For example, the computational node 302 performing stage 216 may receive inputs from a computational node 302 performing the stage 214. Data routing between two stages may be controlled by the computational node 302 performing the immediate predecessor stage.

In the event processing pipeline 202, the stage 218 for topic-based matching may involve a database join of events and subscriptions by topic. Similarly stage 220 may also involve looking up specific information, for example, a user-defined function specific to a user subscription to a topic, from a distributed data store. Remote lookups (read from another computing node) lead to inefficiencies. These inefficiencies may be due to higher access latencies, network congestion, and high memory usage. The higher access latencies are higher across computing nodes compared to within a node. The high memory usage may result from the overlay of compute and storage nodes in the system. In case of remote lookup, each node needs to store both the data fetched from other nodes and then serve to other nodes' data access request, resulting in increased memory consumption. In the shared cluster environment 300, every computational node 302 may act as both a compute unit that processes data and a storage unit that serves data to compute nodes. During execution, computational units cache data to be processed and storage units cache data to be served. Hence, each node caches two kinds of data leading to greater memory consumption. However, each node has limited memory and such memory usage may limit the amount of data looked up. In one embodiment, a storage-aware scheduling mechanism (not shown) may assign a computing task to each computational node 302, such that the computing on each computation node 302 may have the input data that is fully stored on the local data store 306, or at least a significant amount of data is stored on the local data store 306. That is, the scheduler is “data locality aware” and allocates the computing task to the computational nodes 302 that are close to the data. Consequently, this computing paradigm may move computation close to data, instead of the traditional way of bringing data close to computation.

The local data 306 may correspond to a few keys, with data corresponding to one key stored contiguously in the underlying storage devices. While scheduling the computation for stage 218, the scheduler executing on a computational node 302 of stage 216 may determine the location of the data for user subscriptions, and schedule task execution on the computation node 302 on which the user subscriptions related data is stored.

Similarly, while scheduling the computation for stage 220, the scheduler executing on a computational node 302 of stage 218 may determine the location of the relevant data for stage 220, and schedule task execution for stage 220, on the computational node 302 that hosts the data about user-defined matching criteria (not shown), to filter the user notifications generated from stage 218, so that the appropriate lookups to the user-defined matching criteria can be locally performed on the computational node 302. Each user's subscription to a topic can have a matching rule defined potentially.

In case of topic-based matching, the key in the computation may be topic. Accordingly, all subscription data corresponding to a topic is stored contiguously. A large number of subscriptions for a topic may lead to all the subscriptions that share the same topic being hosted on a number of nodes. The scheduler may schedule the task execution that involves the subscription lookups corresponding to a particular topic onto the same computational node 302 that stores the subscriptions to that topic. In one embodiment, a metadata server may be queried to determine the data distribution information across the shared cluster environment 300, for example, to determine which computational nodes store all the user subscriptions corresponding to a particular topic.

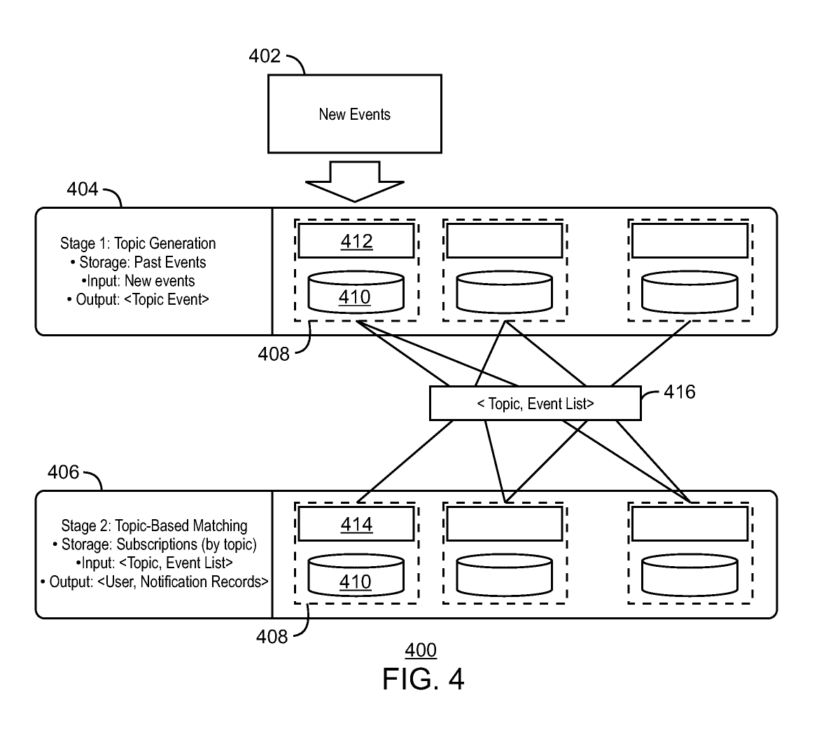

FIG. 4 is a data flow diagram 400 of stages 404, 406 in accordance with an embodiment. In this environment, each stage of the pipeline may be performed on different computational nodes 408. The topic generation stage 404 may receive new events 402 as input. The events 402 may be output from an access-control enforcement stage 214. The events 402 may be distributed to multiple computational nodes 408, each with local data 306. In one embodiment, the inputs 402 may be distributed based on the local data 410, in which the local data 410 represents the storage of the tuples in the format of <topic, event>. For each topic, both the new events that are just published and have not been processed, and the historical events that have been processed, are stored in the same data store 204. In stage 404, a scalable matching engine 412 may perform topic generation, with the output of <topic, event list>. Similarly, the scalable matching engine 414 may perform topic-based matching between the tuples of <topic, event list> and the tuples of <topic, user subscriptions>, and produce the output of <user, notification records>.

In one embodiment, the events 402 may be persisted as transient events (that is, the events that have not been processed yet) in the different, scalable, structured data stores (not shown). For example, transient events may be partitioned and distributed to the different computational nodes 408, with the partitioning scheme that is based on the topic that the event belongs to. The scalable matching engine 412 may read transient events and extract the topics. Tuples 416 may be output, each consisting of a topic and associated transient events, that is, the new events 402 that belong to the same topic. Once the tuples 416 are produced, the transient events may be moved to become the historical events for later reference.

In stage 406, the scalable matching engine 414 may match the tuples 416 against user-subscriptions (conceptually stored in the data store 206, but physically stored in multiple local data 306 that belongs to different computational nodes 302). This matching may identify subscriptions 206 related to the topics in the tuples 416. In one embodiment, better performance may be achieved by aggregating events from the earlier stage by topic. As shown, the input to each computational node 408 may be partitioned. The partitioning may be based on topics, with each computational node 408 processing a subset of topics.

For each tuple 416, the scalable matching engine 414 may look up subscriptions corresponding to the topic. For each subscription, the scalable matching engine 414 may identify all events based on related topics. The scalable matching engine 414 may generate intermediate notification records (not shown). The intermediate notification records may each include information about an event and an associated subscription. In a subsequent stage for content-based subscription matching (not shown), another scalable matching engine may filter the intermediate notification records based on the content of the corresponding new event 402.

During some stages of the pipeline execution, execution may fail, for example, due to machine failures. In a traditional parallel data analysis model, for a given data input, a processing stage performs execution on data and produces output. The data output may become visible externally only upon successful completion of the processing stage. Such a traditional model does not allow for side-effects. Side-effects happen when the processing stage execution has communication with external computational nodes and introduces state changes to these external computation nodes. When the processing stage execution is restarted after a failure, if the introduced state changes cannot be reset, it will leave the side-effects behind. A traditional data analysis model is designed with the assumption that no side effects will occur. However, the notification service 200 assumes side-effects can happen and is designed to deal with the potential side-effects.

Referring back to FIG. 2, at stage 218, the transient events may be processed and moved to a different logical location in a data store 204. The two event-related operations can be described as DeleteTransEvent and AddPastEvent in a pipeline stage's execution. Accordingly, there are two kinds of failures that may be handled by the notification service 200. One kind is the transient failure that might occur between these two data-commit operations (that is, DeleteTransEvent and AddPastEvent) that operate on a single event. By using a data-transaction enclosing the above two data operations as shown in Code Segment 1. Either both or none of the operations may be committed.

CODE SEGMENT 1

begin transaction

DeleteTransEvent (event);
AddPastEvent (event);

end transaction

The second kind of failure is when the computation node 302 fails during the distributed execution of a pipeline stage. The computation node 302 may be replayed, potentially on a different computational node 302, and may not be aware of the side-effects witnessed or committed in the initial execution. For example, in stage 216, topic-generation, the transient event may be moved to a past events family. If the computational node 302 fails after such movement, the subsequent replay execution may not receive that event as input and the event may be lost in the pipeline 202.

This second failure may be handled by using transaction support at the pipeline stage level. Accordingly, changes to persistent storage may not be committed until the computation finishes. A write buffer may be used to store the writes (to a distributed store) within the computation to a local store. A read list corresponding to the reads from the distributed store may be maintained. When the computation completes, the write buffer may be committed to the distributed store if there are no conflicts. Conflict detection may involve verifying timestamps on items read against their current timestamps to detect changes.

Referring also to FIGS. 2 and 3, once the pipelines 202, 210 are established to form a data flow network, each computational node 302 may be dedicated to a particular stage in a particular pipeline. As such, there may be no job re-scheduling or task re-scheduling and re-launch of the execution environment of the computation nodes 302. The notification service 200 may be stream oriented. An input event stream may travel across the event processing pipeline 202 with minimum buffering involved. This is different from the traditional event batch-processing system, in which processing stages are batched on an accumulated set of input data in a sufficiently large time window, instead of processing the input data at real time as it arrives to the notification service 200.

The notification service 200 may provide several advantageous features. A scalable event matching engine realized by a machine cluster may efficiently and reliably match incoming events with user-defined subscriptions, support content filtering and user-defined matching criteria, and produce user notification results. Additionally, a scalable notification delivery engine realized by a machine cluster may aggregate notifications corresponding to a user, and reliably deliver aggregated notifications to subscribers through user-defined channels. Further, a data flow processing pipeline that consists of the scalable matching engine and the scalable notification delivery engine may continuously receive incoming events, process the received events, and deliver user notifications.

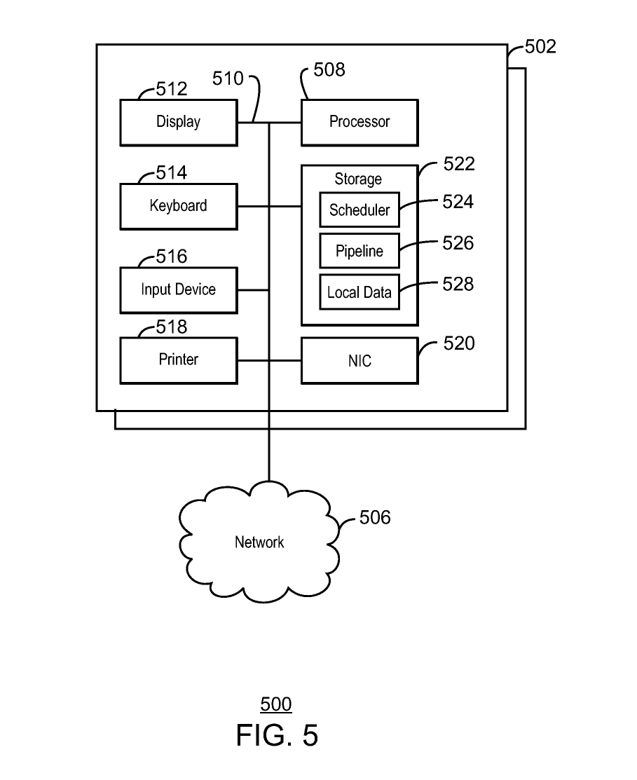

FIG. 5 is a block diagram of a system 500 for pipelined notification in accordance with an embodiment. The functional blocks and devices shown in FIG. 5 may comprise hardware elements, software elements, or some combination of software and hardware. The hardware elements may include circuitry. The software elements may include computer code stored on a non-transitory, computer-readable medium. Additionally, the functional blocks and devices of the system 500 are but one example of functional blocks and devices that may be implemented in an embodiment. Specific functional blocks may be defined based on design considerations for a particular electronic device.

The system 500 may include computational nodes 502, in communication over a network 506. Each of the computational nodes 502 may include a processor 508, which may be connected through a bus 510 to a display 512, a keyboard 514, an input device 516, and an output device, such as a printer 518. The input devices 516 may include devices such as a mouse or touch screen. The computational nodes 502 may also be connected through the bus 510 to a network interface card 520. The network interface card 520 may connect the computational nodes 502 to the network 506.

The network 506 may be a local area network, a wide area network, such as the Internet, or another network configuration. The network 506 may include routers, switches, modems, or any other kind of interface device used for interconnection. In one example embodiment, the network 506 may be the Internet.

The computational nodes 502 may have other units operatively coupled to the processor 512 through the bus 510. These units may include non-transitory, computer-readable storage media, such as storage 522. The storage 522 may include media for the long-term storage of operating software and data, such as hard drives. The storage 522 may also include other types of non-transitory, computer-readable media, such as read-only memory and random access memory.

The storage 522 may include the machine readable instructions used in embodiments of the present techniques. In an embodiment, the storage 522 may include a scheduler 524, a pipeline 526, and local data 528. The pipeline 526 may perform functionality described herein with respect to a specific stage of a particular pipeline 202, 210. The scheduler 524 may route the output of the pipeline 526 to another computational node 502 based on the local data 528 stored at the computational node 502.

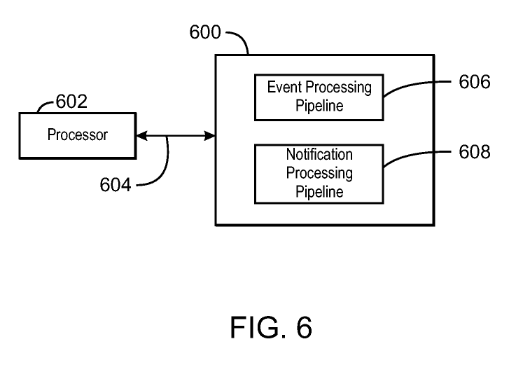

FIG. 6 is a block diagram showing a non-transitory, computer-readable medium that stores code for processing notifications in accordance with an embodiment. The non-transitory, computer-readable medium is generally referred to by the reference number 600.

The non-transitory, computer-readable medium 600 may correspond to any typical storage device that stores computer-implemented instructions, such as programming code or the like. For example, the storage device may include a hard disk drive, a magnetic disk drive, e.g., to read from or write to a removable magnetic disk, and an optical disk drive, e.g., for reading a CD-ROM disk or to read from or write to other optical media. Further, other types of media that are readable by a computer system and that are suitable to the desired end purpose may be used, such as magnetic cassettes, flash memory cards, digital video disks, Bernoulli cartridges, and the like.

The storage device may be connected to a system bus by a storage device interface, such as a hard disk drive interface, a magnetic disk drive interface, and an optical drive interface. For example, the storage device may be the storage 522 discussed with respect to FIG. 5.

When read and executed by a processor 602 via a communication path 604, the instructions stored on the non-transitory, computer-readable medium 600 are adapted to cause the processor 602 to process notifications according to an example embodiment, as described herein.

The medium 600 may include an event processing pipeline 606, and a notification processing pipeline 608. The event processing pipeline 606 may generate notifications for a number of subscribers to a number of topics. The notifications may be generated based on events that include the plurality of topics.

The notification processing pipeline 608 may send the notifications for the subscribers, concurrently with generating a second set of notifications for a second group of subscribers to a second set of topics. The second set of notifications are generated based on a second set of events comprising the second set of topics. The notification processing pipeline 608 may also send the second set of notifications for the second set of subscribers.

What is claimed is:

1. A method of processing notifications, comprising:
generating a plurality of notifications for a plurality of subscribers to a plurality of topics, wherein the plurality of notifications are generated based on a plurality of events comprising the plurality of topics; and
sending the plurality of notifications for the plurality of subscribers, concurrently with generating a second plurality of notifications for a second plurality of subscribers to a second plurality of topics, wherein the second plurality of notifications are generated based on a second plurality of events comprising the second plurality of topics.

2. The method recited in claim 1, wherein generating the plurality of notifications comprises an event processing pipeline, comprising:
performing access control enforcement for the plurality of events;
performing topic generation for the plurality of events;
performing topic-based subscription matching for the plurality of events; and
performing content-based subscription matching for the plurality of events.

3. The method recited in claim 2, wherein performing access control enforcement comprises:
determining a permission for each of a plurality of publishers of the plurality of events; and
restricting a publication of each of the plurality of events based on the permission.

4. The method recited in claim 2, wherein performing topic generation comprises identifying the plurality of topics for the plurality of events based on an association between the events and the topics specified by publishers publishing the events.

5. The method recited in claim 2, wherein performing topic-based subscription matching for the plurality of events comprises identifying the plurality of subscribers based on the plurality of topics.

6. The method recited in claim 2, wherein performing content-based subscription matching comprises identifying the plurality of subscribers based on a plurality of content, wherein the plurality of events comprises the plurality of content.

7. The method recited in claim 1, wherein sending the plurality of notifications for the plurality of subscribers, comprises a notification processing pipeline, comprising:
aggregating the plurality of events to each of the subscribers; and
sending to each of the plurality of subscribers, one notification comprising the aggregated events.

8. The method recited in claim 7, comprising:
determining that one or more of the plurality of notifications are not delivered by an execution of the notification processing pipeline;
re-sending the one or more of the plurality of notifications during a subsequent execution of the notification processing pipeline.

9. A computer system for processing notifications, comprising:
an event processing pipeline, comprising:
a memory storing instructions;
a processor configured to execute the instructions to:
generate a plurality of notifications for a plurality of subscribers to a plurality of topics, wherein the plurality of notifications are generated based on a plurality of events comprising the plurality of topics; and
a notification processing pipeline, comprising:
a second memory storing instructions;
a second processor configured to execute the instructions to:
send the plurality of notifications for the plurality of subscribers, concurrently with generating a second plurality of notifications for a second plurality of subscribers to a second plurality of topics, wherein the second plurality of notifications are generated based on a second plurality of events comprising the second plurality of topics.

10. The computer system recited in claim 9, wherein the event processing pipeline comprises a plurality of computational nodes, wherein each of the computational nodes generates a subset of the plurality of notifications, and wherein the computational node that generates the subset is determined based on at least one of:
one or more topics stored at the computational node; and
one or more subscriptions stored at the computational node.

11. The computer system recited in claim 9, wherein the notification processing pipeline comprises a plurality of computational nodes, wherein each of the computational nodes sends a subset of the plurality of notifications.

12. The computer system recited in claim 9, wherein the processor is configured to execute the instructions to generate the plurality of notifications by executing instructions to:
perform access control enforcement for the plurality of events;
perform topic generation for the plurality of events;
perform topic-based subscription matching for the plurality of events; and
perform content-based subscription matching for the plurality of events.

13. The computer system recited in claim 12, wherein the processor is configured to execute the instructions to perform access control enforcement by executing instructions to:
determine a permission for each of a plurality of publishers of the plurality of events; and
restrict a publication of each of the plurality of events based on the permission.

14. The computer system recited in claim 12, wherein the processor is configured to execute the instructions to perform topic generation by executing instructions to identify the plurality of topics for the plurality of events based on an association between the events and the topics specified by publishers publishing the events.

15. The computer system recited in claim 12, wherein the processor is configured to execute the instructions to perform topic-based subscription matching for the plurality of events by executing instructions to identify the plurality of subscribers based on the plurality of topics.

16. The computer system recited in claim 12, wherein the processor is configured to execute the instructions to perform content-based subscription matching by executing instructions to identify the plurality of subscribers based on a plurality of content, wherein the plurality of events comprises the plurality of content.

17. The computer system recited in claim 9, wherein the second processor is configured to execute the instructions to send the plurality of notifications for the plurality of subscribers by executing instructions to:
aggregate the plurality of events to each of the subscribers; and
send to each of the plurality of subscribers, one notification comprising the aggregated events.

18. A non-transitory, computer-readable medium comprising machine-readable instructions executable by a processor to:
generate a plurality of notifications for a plurality of subscribers to a plurality of topics, wherein the plurality of notifications are generated based on a plurality of events comprising the plurality of topics;
sending the plurality of notifications for the plurality of subscribers, concurrently with generating a second plurality of notifications for a second plurality of subscribers to a second plurality of topics, wherein the second plurality of notifications are generated based on a second plurality of events comprising the second plurality of topics; and
send the second plurality of notifications for the second plurality of subscribers.

19. The non-transitory, computer-readable medium recited in claim 18, wherein the machine-readable instructions which, when executed by the processor, cause the processor to generate the plurality of notifications comprise machine-readable instructions which, when executed by the processor, cause the processor to:
perform access control enforcement for the plurality of events;
perform topic generation for the plurality of events;
perform topic-based subscription matching for the plurality of events; and
perform content-based subscription matching for the plurality of events.

20. The non-transitory, computer-readable medium recited in claim 18, wherein the machine-readable instructions which, when executed by the processor, cause the processor to send the plurality of notifications comprise machine-readable instructions which, when executed by the processor, cause the processor to:
aggregate the plurality of events to each of the subscribers; and
send to each of the plurality of subscribers, one notification comprising the aggregated events.
